(19) United States
(12) Patent Application Publication
(10) Pub. No.: US 2024/0217226 A1
(43) Pub. Date: Jul. 4, 2024

(54) Device and Method for Manufacturing an Electrode

(71) Applicant: Volkswagen Aktiengesellschaft, Wolfsburg (DE)

(72) Inventors: Ludger BUßWINKEL, Braunschweig (DE); Sebastian REUBER, Dresden (DE); Roland SCHMIDT-LOBACH, Hörsingen (DE); Sven SCHOPF, Braunschweig (DE)

(73) Assignee: Volkswagen Aktiengesellschaft, Wolfsburg (DE)

(21) Appl. No.: 18/402,080

(22) Filed: Jan. 2, 2024

(30) Foreign Application Priority Data
Jan. 3, 2023 (DE) 10 2023 200 011.3

(51) Int. Cl. B32B 37/00; H01M 4/04; H01M 4/139

(52) U.S. Cl. CPC B32B 37/156; H01M 4/0409; H01M 4/0435; H01M 4/139; B32B 2307/72; B32B 2307/7376; B32B 2309/02; B32B 2309/105; B32B 2309/14; B32B 2457/10

(57) ABSTRACT

The disclosure relates to a method for manufacturing an electrode with a substrate and with a first dry film, wherein to form a first dry film, solvent-free dry film material is brought into a first nip formed between a first roller and a second roller. The first dry film formed in the first nip is conveyed roller-borne into a second nip formed between the second roller and a third roller and compressed there. For laminating, the compressed first dry film and the substrate are conveyed into a third nip formed between the third roller and a fourth roller, wherein the first dry film is conveyed roller-borne into the third nip. Moreover, the disclosure relates to a corresponding device for manufacturing the electrode.

### CROSS-REFERENCE TO RELATED APPLICATIONS

This application claims priority to German Patent Application No. DE 10 2023 200 011.3, filed on Jan. 3, 2023 with the German Patent and Trademark Office. The contents of the aforesaid Patent Application are incorporated herein for all purposes.

### BACKGROUND

The disclosure relates to a device and a method for manufacturing an electrode which comprises a substrate and a dry film layer with active material.

This background section is provided for the purpose of generally describing the context of the disclosure. Work of the presently named inventor (s), to the extent the work is described in this background section, as well as aspects of the description that may not otherwise qualify as prior art at the time of filing, are neither expressly nor impliedly admitted as prior art against the present disclosure.

To manufacture an electrode with a substrate and with a dry film, first a dry film material is conveyed using a powder conveyor between two rollers of a roller device. By using these rollers, pressure and/or shear forces are introduced into the dry film material so that the dry film forms. The dry film is conveyed on one of the rollers into another gap. In so doing, a substrate is additionally fed through this additional gap so that the dry film is laminated to the substrate.

In such a manufacturing method, the dry film has a comparatively low density. This is disadvantageous with regard to energy and/or power density for direct use in a battery of a motor vehicle so that the dry film is typically recompressed. For this purpose, the dry film is recompressed, for example, while laminating the substrate with the dry film. However, a risk exists of wrinkling in an arrester area of the substrate and/or the risk of a crack in the substrate, in particular due to inhomogeneities.

### SUMMARY

A need exists to provide a particularly suitable method and/or a particularly suitable device for manufacturing an electrode with a substrate and with a dry film.

The need is addressed by the subject matter of the independent claim (s). Embodiments are described in the dependent claims, the following description, and the drawings.

### BRIEF DESCRIPTION OF THE DRAWINGS

FIG. 1 shows a device for manufacturing an electrode in a first embodiment;

FIG. 2 shows the device in a second embodiment;

FIG. 3 shows the device in a third embodiment;

FIG. 4 shows a flow chart of a method sequence for manufacturing the electrode according to a first embodiment; and

FIG. 5 shows a flow chart of a method sequence for manufacturing the electrode according to a second embodiment.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description. It is noted that any statement herein associated with the discussed device may also apply analogously to the discussed method and vice versa.

Some embodiments relate to a method for manufacturing an electrode, for example for a lithium-ion battery. In this case, the electrode comprises a substrate, for example a foil-like substrate such as a metal foil, and a first dry film, which is arranged on a first side of the substrate, for example joined to the substrate, for example laminated onto the substrate. The substrate for example forms a current collector of the electrode. The dry film expediently forms a layer with active material which is provided for example for an anode or for a cathode of a lithium-ion battery.

In some embodiments, in a first step to form a first dry film, solvent-free dry film material is brought, for example conveyed, into a first nip, which first nip is formed between a first roller and a second roller. The dry film material conveyed into the first nip is processed using the first and the second roller into the first dry film. For this purpose, a pressing and/or shearing force may be generated on the dry film material using the first and second roller so that the particles of the dry film material bond together.

The dry film material is for example a granular material also described as a granulate, for example a powder or a powder mixture. The dry film material may have a (dry) active material, a (dry) binder, and/or a (dry) conductive agent. In other words, the dry film material may comprise a mixture consisting of undissolved active material particles, undissolved binder particles, and/or undissolved conductive agent particles.

In a second step and in some embodiments, the first dry film formed in the first nip is conveyed roller-borne into a second nip, which is formed between the second roller and a third roller. In other words, the first dry film is conveyed using the second roller from the first nip into the second nip. In so doing, the first dry film is not free-standing, but is arranged on the second roller for conveyance from the first nip to the second nip, and is for example borne, that is, entrained, thereby.

By using the second and the third roller, the first dry film is compressed in the second nip. The first dry film is for example compressed to a specified target density or a specified target thickness. The target density, or respectively the target thickness is for example the density, or respectively thickness which the dry film should have after the manufacture of the electrode, that is, also in its use in a battery cell, for example a Li-ion battery cell. The target density, or respectively the target thickness is hence for example selected such that additional compression of the dry film is unnecessary and is in some embodiments also not carried out. Accordingly, recompression of the first dry film during lamination onto the substrate (see step three) is unnecessary. Alternatively, a comparatively low line load is used for this purpose. As a result, the risk of damage to the first dry film and/or the substrate during recompression may be avoided.

In summary, the second method step serves to compress the first dry film.

In a third step of the method and in some embodiments, the compressed first dry film and the substrate are conveyed into a third nip, which is formed between the third roller and a fourth roller. In so doing, the first dry film is conveyed roller-borne on the third roller into the third nip. In a suitable manner, the substrate is conveyed into the third nip between the first dry film, borne on the third roller, and the fourth roller. In the third nip, the substrate is laminated together around the compressed first dry film. In so doing, the line load is selected such that the first dry film is reliably, that is, securely, bonded to the substrate. For example, the dry film is recompressed in the third nip; however, a comparatively low line load is used for this purpose to avoid cracks or wrinkling. In some embodiments, a greater line load than that needed for lamination is not used.

For example, the line load for the film formation in the first gap is between 200 N/mm and 2000 N/mm; the line load for the compression in the second gap is between 500 N/mm and 4000 N/mm, and/or the line load for the lamination is between 200 N/mm and 2000 N/mm.

Due to the roller-borne conveyance of the first dry film both from the first nip to the second nip and from the second nip to the third nip, it is possible to manufacture the first dry film comparatively thin, and/or reduce the amount of binder. Accordingly, in comparison to the manufacture of the first dry film as a free-standing dry film, that is, manufacturing when the first dry film is conveyed free-standing, in particular without support, a requirement for its mechanical stability is reduced.

According to some embodiments, the substrate is provided on its second side with a second dry film.

In some embodiments of a first variant, solvent-free dry film material is brought, for example conveyed, into a fourth nip for this purpose in a manner analogous to the first step of the method, which fourth nip is formed between a fifth roller and a sixth roller. The dry film material conveyed into the first nip is processed into the second dry film using the fifth and sixth roller. For example, the same dry film material is used for the second dry film as for the first dry film; alternatively thereto, a different dry film material is used.

Then in a manner analogous to the second step, the second dry film formed in the fourth nip is conveyed roller-borne on the sixth roller into a fifth nip, which is formed between the sixth roller and a seventh roller. The second dry film is therefore conveyed using the sixth roller from the fourth nip into the fifth nip. In so doing, the second dry film is not free-standing, but is arranged on the sixth roller for conveyance from the fourth nip to the fifth nip, and is for example borne, that is, entrained, thereby.

By using the sixth and the seventh roller, the second dry film is compressed in the fifth nip. The second dry film is expediently compressed to a specified target density or a specified target thickness. The target density, or respectively the target thickness for the second dry film is for example the density, or respectively thickness which the dry film should have after the manufacture of the electrode, that is, also in its use in a battery cell, for example a Li-ion battery cell. The target density, or respectively the target thickness is for example selected such that additional compression of the second dry film is unnecessary and is expediently also not carried out. Accordingly, recompression of the second dry film during lamination onto the substrate is unnecessary. As a result, the risk of damage to the first dry film, the second dry film, and/or the substrate during recompression is avoided or reduced. Alternatively, a comparatively low line load is used for slight compression. In summary, the dry film is accordingly recompressed in the fifth nip, for example, but a comparatively low line load is used for this in order to avoid cracks or wrinkling. In some embodiments, a greater line load than that needed for lamination is not used.

Subsequently, the compressed second dry film and the substrate provided, for example laminated, with the first dry film are conveyed into a sixth nip, which is formed between the seventh roller and an eighth roller. In so doing, the second dry film is conveyed roller-borne on the seventh roller into the sixth nip. In some embodiments, the second dry film is conveyed into the sixth nip such that the substrate is arranged between the first dry film and the second dry film. In the sixth nip, the compressed second dry film is laminated onto the second side of the substrate. In so doing, the line load is selected such that the first and the second dry film are reliably, that is, securely, bonded to the substrate. A greater line load for additional compression of the first, or respectively second dry film is, however, unnecessary and is at least in some embodiments not used.

For example, the line load for the film formation in the fourth gap is between 200 N/mm and 2000 N/mm. For example, the line load for the compression in the fifth gap is between 500 N/mm and 4000 N/mm. For example, the line load for the lamination in the sixth gap is between 200 N/mm and 2000 N/mm.

In summary, in this first variant embodiment, the first, second, third and fourth rollers are used to form the first dry film, said film is compressed and laminated onto the first side of the substrate. By using the fifth, sixth, seventh and eighth roller, the second dry film is formed, said film is compressed and laminated onto the second side of the substrate provided with the first dry film.

For example, the first to fourth rollers are arranged in a row, that is, their axes are oriented parallel to each other and arranged in a common first plane. The fifth to eighth rollers are for example also arranged in a row, that is, their axes are oriented parallel to each other and arranged in a common second plane, wherein said plane is for example parallel and spaced or inclined relative to the first plane. Due to the arrangement of the respective rollers in a row, an arching of the rollers due to the line loads is avoided or at least reduced.

According to some embodiments of a second variant, solvent-free dry film material is brought, for example conveyed, into a fourth nip in a manner analogous to the first step of the method, which fourth nip is formed between a fifth roller and a sixth roller. The dry film material conveyed into the first nip is processed into the second dry film using the fifth and sixth roller. For example, the same dry film material is used for the second dry film as for the first dry film; alternatively thereto, a different dry film material is used.

Then in a manner analogous to the second step, the second dry film formed in the fourth nip is conveyed roller-borne on the sixth roller into a fifth nip, which is formed between the sixth roller and the fourth roller. The second dry film is therefore conveyed using the sixth roller from the fourth nip into the fifth nip. In so doing, the second dry film is not free-standing, but is arranged on the sixth roller for conveyance from the fourth nip to the fifth nip, and is for example borne, that is, entrained, thereby.

By using the sixth and the fourth roller, the second dry film is compressed in the fifth nip. The second dry film is for example compressed to a specified target density or a specified target thickness. The target density, or respectively the target thickness is for example the density, or respectively thickness which the dry film should have after the manufacture of the electrode, that is, also in its use in a battery cell, in particular a Li-ion battery cell. The target density, or respectively the target thickness is for example selected such that additional compression of the second dry film is unnecessary and is expediently also not carried out. Accordingly, recompression of the second dry film during lamination onto the substrate is unnecessary. Alternatively, a comparatively low line load is used for slight compression. As a result, the risk of damage to the first dry film and/or the substrate during recompression is avoided or reduced.

Subsequently, the compressed second dry film, the first dry film and the substrate are conveyed into the third nip. In doing so, the second the dry film is conveyed roller-borne on the fourth roller into the third nip. In some embodiments, the second dry film is conveyed into the third nip such that the substrate is arranged between the first dry film and the second dry film. In the third nip, the compressed first dry film is laminated onto the first side of the substrate, and the compressed second dry film is laminated onto the second side of the substrate. Accordingly, the first and second dry films are laminated onto the substrate together in the third nip. In other words, the first dry film is laminated onto the substrate according to the third step together with the lamination of the second dry film. In so doing, the line load is selected such that the first and the second dry film are reliably, that is, securely, bonded to the substrate. A greater line load for additional compression of the first, or respectively second dry film is, however, unnecessary and is at least in some embodiments not used.

For example, the line load for the film formation in the fourth gap is between 200 N/mm and 2000 N/mm. For example, the line load for the compression in the fifth gap is between 500 N/mm and 4000 N/mm. For example, the line load for the lamination in the third gap is between 200 N/mm and 2000 N/mm.

In summary, in this second variant embodiment, the first, second, third and fourth rollers are used to form the first dry film, said film is compressed, and laminated onto the first side of the substrate. By using the fifth, sixth, fourth and third roller, the second dry film is formed, said film is compressed, and laminated onto the second side of the substrate.

For example, the first to sixth rollers are arranged in a row, that is, their axes are oriented parallel to each other and arranged in a common plane. The roller arrangement is therefore symmetrically configured. Due to the arrangement of the rollers in a row, an arching of the rollers due to the line loads is avoided or at least reduced.

To summarize further, in all variants, the first and/or the second dry film are conveyed only roller-borne up to the lamination with the substrate. Accordingly, such thicknesses and/or densities of the first, or respectively the second dry film can also be realized which are unsuitable for free-standing, that is, non-roller-borne conveyance due to poor mechanical stability.

In some embodiments, the first dry film in the second nip and/or the second dry film in the sixth nip are each compressed to a density between 1.0 g/cm³ and 4 g/cm³, for example between 1.4 g/cm³ and 3.7 g/cm³. In other words, the first dry film in the second nip and/or the second dry film in the sixth nip are each compressed such that the first, or respectively the second dry film has a density after compression between 1.0 g/cm³ and 4 g/cm³, for example between 1.4 g/cm³ and 3.7 g/cm³.

In some embodiments, additionally or alternatively thereto, the first dry film in the second nip and/or the second dry film in the sixth nip is compressed in each case to a thickness between 10 μm and 200 μm, for example to a thickness between 30 μm and 150 μm, for example between 40 μm and 120 μm. In other words, the first dry film is compressed in the second nip and/or the second dry film is compressed in the sixth nip such that the first, or respectively second dry film has a thickness after compression between 10 μm and 200 μm, for example a thickness between 30 μm and 150 μm, for example between 40 μm and 120 μm. For this purpose, the second, or respectively the sixth nip has a corresponding gap width, in some embodiments a gap width between 10 μm and 200 μm, for example between 30 μm and 150 μm, for example between 40 μm and 120 μm.

The thickness, or respectively the density is adjusted depending on the type of electrode, that is, whether the electrode is an anode or a cathode, and/or depending on the intended use of the electrode, for example corresponding to a requirement for a power density and/or an energy density for a battery cell with such an electrode.

In some embodiments, the circumferential speed of the second roller is and/or will be adjusted to be greater than that of the first roller. Additionally or alternatively thereto and in some embodiments, the circumferential speed of the third roller is and/or will be adjusted to be greater than the circumferential speed of the second roller. For example, the level of the circumferential speeds of the third and fourth rollers is equal.

For example, analogously thereto, in the first variant and in the second variant, the circumferential speed of the sixth roller is adjusted to be greater than that of the fifth roller. In the first variant, additionally or alternatively thereto and in some embodiments, the circumferential speed of the seventh roller is and/or will be adjusted to be greater than the circumferential speed of the sixth roller. In the second variant, additionally or alternatively thereto and in some embodiments, the circumferential speed of the fourth roller is and/or will be adjusted to be greater than the circumferential speed of the sixth roller.

For example, in doing so, the two rollers of the respective roller pair (that is, the first and second roller, the second and third roller, the sixth and seventh roller, or respectively the seventh and eighth roller) have the same diameter, the angular velocity, that is, the number of revolutions, of the second roller is greater than that of the first roller. Moreover for example, if the angular velocity of the first and second rollers is the same, the diameter of the second roller is greater than the diameter of the first roller.

The greater circumferential speed of one of the rollers of the respective roller pair results in the first, or respectively second dry film being borne comparatively reliably on the roller with the greater circumferential speed, and/or the elongation of the dry film being restrictable, that is, compensated, during compression.

For example, the ratio of the circumferential speed, for example the rotational speed, of the faster rotating roller to the circumferential speed, for example the rotational speed, of the slower rotating roller of the roller pair forming the respective nip is between 3:1 and 20:1, for example between 4:1 and 10:1.

Alternatively or additionally thereto and in some embodiments-, the temperature of the second roller is and/or will be adjusted to be greater than the temperature of the first roller. Additionally or alternatively thereto and in some embodiments, the temperature of the third roller is and/or will be adjusted to be greater than the temperature of the second roller. For example, the temperature of the third and fourth roller is equal.

For example, a higher temperature is selected for compressing than for laminating. Even though this may be unfavorable for the reliability of being borne by a roller, it is however beneficial for compressing and/or laminating.

For example, analogously thereto, in the first variant and in the second variant, the temperature of the sixth roller is adjusted to be greater than that of the fifth roller. In the first variant, additionally or alternatively thereto and in some embodiments, the temperature of the seventh roller is and/or will be adjusted to be greater than the temperature of the sixth roller. In the second variant, additionally or alternatively thereto and in some embodiments, the temperature of the fourth roller is and/or will be adjusted to be greater than the temperature of the sixth roller.

For example, the difference between the temperature of the warmer roller and the temperature of the cooler roller of the roller pair forming the respective nip is between 1° C. and 50° C., for example between 1 and 20° C., and for example between 5° C. and 20° C.

The greater temperature of one of the rollers of the respective roller pair results in the first, or respectively second dry film being borne comparatively reliably on the roller with the greater temperature.

Alternatively or additionally thereto and in some embodiments, the surface of the second roller has a greater roughness than the surface of the first roller. Alternatively or additionally and in some embodiments, the surface of the third roller has a greater roughness than the surface of the second roller.

For example, analogously thereto, in the first variant and in the second variant, the roughness of the surface of the sixth roller is greater than that of the fifth roller. In the first variant, additionally or alternatively thereto and in some embodiments, the roughness of the surface of the seventh roller is greater than the roughness of the surface of the sixth roller. In the second variant, additionally or alternatively thereto and in some embodiments, the roughness of the surface of the fourth roller is greater than the roughness of the surface of the sixth roller.

The greater roughness of the surface of one of the rollers of the respective roller pair results in the first, or respectively second dry film being borne comparatively reliably on the roller with the greater surface roughness.

Some embodiments relate to a device for manufacturing an electrode, which has substrate and a first dry film, provided according to the method in one or more of the embodiments discussed in the preceding. The device accordingly comprises at least the first, the second, the third, and the fourth roller.

A first nip is formed between the first and second roller. Moreover, the device comprises a conveying apparatus, for example a so-called hopper, for conveying solvent-free dry film material into the first nip.

Moreover, the second nip is formed between the second and third roller to compress the first dry film formed in the first nip.

Moreover, the device comprises a feeding apparatus (feed) for feeding the substrate into the third nip formed between the third and the fourth roller.

In some embodiments, the first, the second, the third and the fourth roller are configured so that the first dry film is or will be roller-borne on the second roller from the first nip to the second nip, and that the first dry film is or will be roller-borne on the third roller from the second nip to the third nip. For this purpose, the angular velocity (rotational speed) or the temperature of each of the rollers is individually adjustable. As shown in connection with the method, the circumferential speed and/or the temperature of the second roller is expediently greater than that of the first roller, and/or the circumferential speed and/or the temperature of the third roller is expediently greater than that of the second roller. In addition or alternatively thereto and in some embodiments, the surfaces of the rollers have different roughnesses as described in connection with the method, wherein for example the roughness of the surface of the second roller is greater than that of the first roller, and/or the roughness of the surface of the third roller is greater than that of the second roller.

For example, the first, the second, the third and the fourth roller are arranged such that their (rotational) axes are oriented parallel to each other and arranged in a common plane. Beneficially, a bending of the rollers (roll bending) is thereby avoided or at least reduced.

In some embodiments, the line load and/or the gap width of the first nip, the second nip and/or the third nip can be adjusted individually, that is, separately and/or independently of each other. Additionally or alternatively thereto and in some embodiments, the gap width in the first nip and/or in the second nip is, or respectively will be regulated. Additionally or alternatively and in some embodiments, the line load, that is, the gap force, is, or respectively will be regulated in the third nip.

In this way, a comparatively exact adjustment of the gap, or respectively of the line load for the different tasks of the respective gap (film formation, compression, or respectively lamination) is enabled in all these variants.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

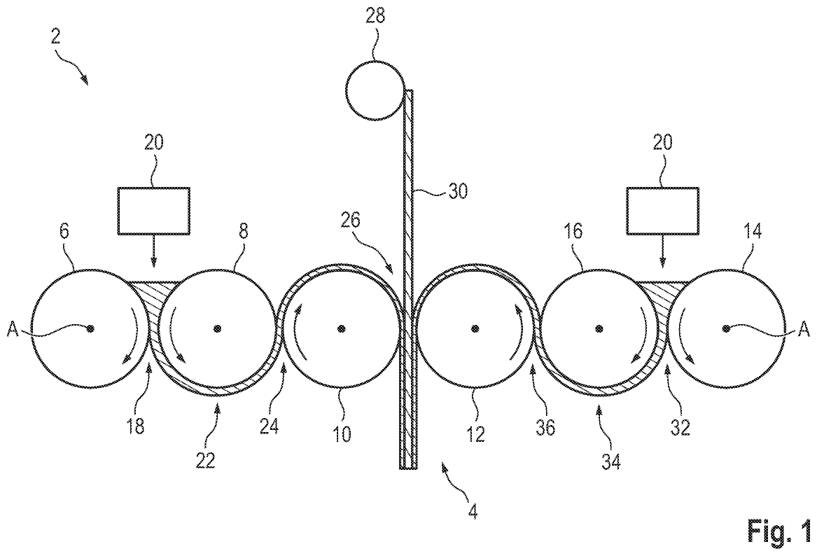

FIG. 1 shows a first embodiment of a device 2, which is provided and configured for manufacturing an electrode 4. Here, the device comprises six rollers, namely a first roller 6, a second roller 8, a third roller 10, a fourth roller 12, a fifth roller 14 and a sixth roller 16. These are arranged in a row; in other words, their (rotational) axes A are arranged parallel to each other and in a common plane. The directions of rotation of all the rollers are each shown by an arrow. According to the embodiment example shown here, the rollers 6 to 16 have the same diameter.

A first nip 18 is formed between the first roller 6 and the second roller 8. In other words, the first and the second roller 6, 8 are arranged at a distance from one another while forming the first nip 18. A conveying apparatus 20, for example designed as a hopper, of the device 2 is configured to convey solvent-free and therefore dry dry film material between the first roller 6 and the second roller 8, and therefore into the first nip 18. The first roller 6 is arranged to the outside in the roller row; in other words, the first roller 6 forms a first row end. The first and the second roller 6, 8 serve to process the dry film material conveyed into the first nip 18 into a first dry film 22.

A second nip 24 is formed between the second roller 8 and the third roller 10. This has a gap width which corresponds to a specified target thickness of the first dry film 22. The second and third rollers 8, 10 are accordingly provided and configured for compressing the first dry film 22. The gap width of the second nip 24 is therefore less than that of the first nip 18.

A third nip 26 is formed between the third roller 10 and the fourth roller 12. A feed apparatus 28, shown here as a guide roller for example, of the device 2 is configured to feed an in particular foil-like substrate 30 into the third nip 26.

The fifth roller 14 is arranged to the outside in the row of rollers; in other words, the fifth roller 14 forms a second row end of the roller row. A fourth nip 32 is formed between the fifth and the sixth roller 16. Another conveying apparatus 20, for example designed as a hopper, of the device 2 is configured to convey solvent-free and therefore dry film material between the fifth roller 14 and the sixth roller 16, and therefore into the fourth nip 32. The fifth and the sixth roller 14, 16 serve to process the dry film material conveyed into the fourth nip 32 into a second dry film 34.

A fifth nip 36 is formed between the sixth roller 16 and the fourth roller 12. This has a gap width which corresponds to a specified target thickness of the second dry film 34. The fourth and the sixth roller 12, 16 are accordingly provided and configured for compressing the second dry film 34. The gap width of the fifth nip 36 is therefore less than that of the fourth nip 32.

The device 2 is configured such that the first dry film 22 formed in the first nip 18 is conveyed roller-borne on the second roller 8 from the first nip 18 into the second nip 24. Furthermore, the device 2 is configured such that the first dry film 22 compressed in the second nip 24 is conveyed roller-borne on the third roller 10 from the second nip 24 into the third nip 26.

For this purpose, a circumferential speed of the second roller 8 is adjusted to be greater than that of the first roller 6; in particular, a rotational speed (angular velocity) of the second roller 8 is greater than the rotational speed of the first roller 6. A circumferential speed of the third roller 10 is adjusted to be greater than that of the second roller 8; in particular, a rotational speed (angular velocity) of the third roller 10 is greater than the rotational of the second roller 8. Alternatively or additionally thereto, the roughness of the surface of the second roller 8 is greater than that of the first roller 6, and the roughness of the surface of the third roller 10 is greater than that of the second roller 8. Additionally or alternatively thereto, the temperature of the second roller 8 is greater than that of the first roller 6, and the temperature of the third roller 10 is greater than that of the second roller 8.

Analogously thereto, the device 2 is configured such that the second dry film 34 formed in the fourth nip 32 is conveyed roller-borne on the sixth roller 16 from the fourth nip 32 into the fifth nip 36. Furthermore, the device 2 is configured such that the second dry film 34 compressed in the fifth nip 36 is conveyed roller-borne on the fourth roller 12 from the fifth nip 24 into the third nip 26.

For this purpose, a circumferential speed of the sixth roller 16 is adjusted to be greater than that of the fifth roller 14; in particular, a rotational speed (angular velocity) of the sixth roller 16 is greater than the rotational speed of the fifth roller 14. A circumferential speed of the fourth roller 12 is adjusted to be greater than that of the sixth roller 16; in particular, a rotational speed (angular velocity) of the fourth roller 12 is greater than the rotational speed of the sixth roller 16. Alternatively or additionally thereto, the roughness of the surface of the sixth roller 16 is greater than that of the fifth roller 14, and the roughness of the surface of the fourth roller 12 is greater than that of the sixth roller 16. Additionally or alternatively thereto, the temperature of the sixth roller 16 is greater than that of the fifth roller 14, and the temperature of the fourth roller 12 is greater than that of the sixth roller 16.

Expediently, the web speed of the first dry film 22, or respectively the second dry film 34 corresponds to the circumferential speed of the third roller 10, or respectively the fourth roller 12.

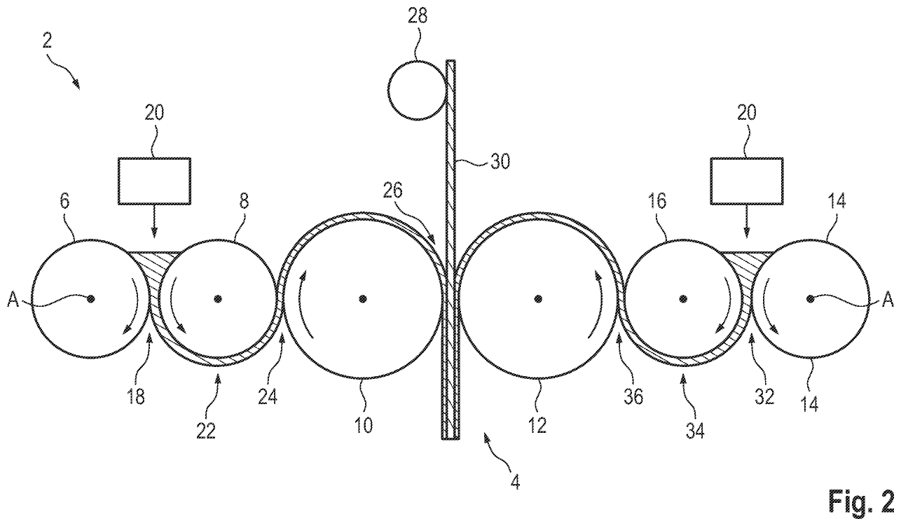

FIG. 2 shows a second embodiment of the device 2. The statements regarding the device 2 in FIG. 1 apply analogously. In contrast to the embodiment of FIG. 1, the diameters of the rollers 6 to 16 are not the same. Accordingly, the diameters of the third and fourth roller 10, 12 are the same size, but larger than the diameter of the first, second, fifth and sixth roller 6, 8, 14, 16. Due to the comparatively large diameter of the third and fourth roller, roll bending of these rollers 10, 12 during lamination of the first and second dry film 22, 34 onto the substrate 30 is avoided, or a risk thereof is at least reduced.

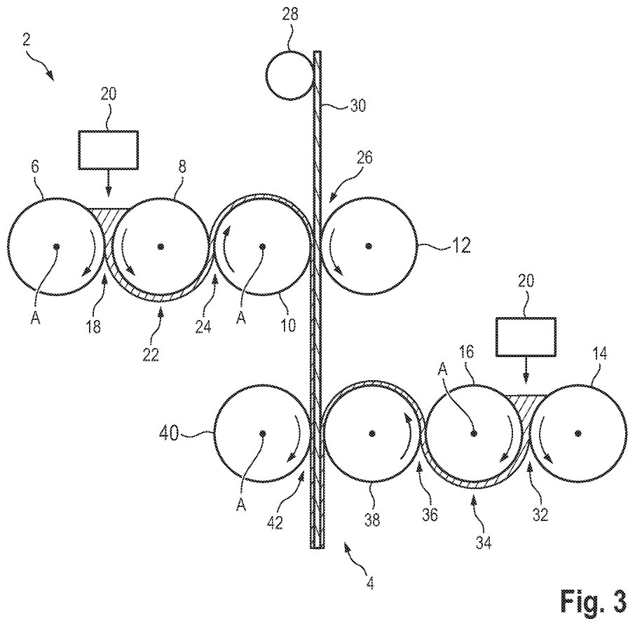

FIG. 3 shows a third embodiment of the device 2. This comprises the first, the second, the third and the fourth roller 6, 8, 10, 12, which are arranged in a first row. The statements regarding the rollers 6 to 10 of the device of the first embodiment apply here analogously; however, the third nip 26 is provided and configured to laminate only the first dry film 22 onto the substrate.

In summary, the device is provided and configured so that the first dry film 22 is formed in the first nip 18 using the first and second roller 6, 8, and that the first dry film 22 formed in the first nip 18 is conveyed roller-borne on the second roller 8 into the second nip 24 and is compressed there using the second and third rollers 8, 10. Furthermore, the device 2 according to the third embodiment is provided and configured so that the compressed first dry film 22 is conveyed from the second nip 24 roller-borne on the third roller 10 into the third nip 26 where the compressed first dry film 22 is laminated onto the substrate 30.

The device 2 according to the third embodiment also comprises a second row of rollers. This second row comprises the fifth roller 14, the sixth roller 16, a seventh roller 38 and an eighth roller 40. The device 2 is provided and configured so that the second dry film 34 is formed in the fourth nip 32 by using the fifth and sixth roller 14, 16, and that the second dry film 34 formed in the fourth nip 32 is conveyed roller-borne on the sixth roller 16 into the fifth nip 36 formed between the sixth and the seventh roller 16, 38 and is compressed there by using the sixth and seventh roller 16, 38. Furthermore, the device 2 according to the third embodiment is provided and configured so that the compressed second dry film 34 is conveyed from the fifth nip 36 roller-borne on the seventh roller 38 into a sixth nip 42 formed between the seventh and eighth roller 38, 40, where the compressed second dry film 34 is laminated onto the substrate 30 provided with the first dry film 22.

For this purpose, with the rollers 14 to 40 of the second roller row, a circumferential speed of the sixth roller 16 is adjusted to be greater than that of the fifth roller 14; in particular, a rotational speed (angular velocity) of the sixth roller 16 is greater than the rotational speed of the fifth roller 14. A circumferential speed of the seventh roller 38 is adjusted to be greater than that of the sixth roller 16; in i particular, a rotational speed (angular velocity) of the seventh roller 38 is greater than the rotational speed of the sixth roller 16. Alternatively or additionally thereto, the roughness of the surface of the sixth roller 16 is greater than that of the fifth roller 14, and the roughness of the surface of the seventh roller 38 is greater than that of the sixth roller 16. Additionally or alternatively thereto, the temperature of the sixth roller 16 is greater than that of the fifth roller 14, and the temperature of the seventh roller 38 is greater than that of the sixth roller 16.

Expediently, the web speed of the first dry film 22 corresponds to the circumferential speed of the third roller 10, and/or the web speed of the second dry film 34 corresponds to the circumferential speed of the seventh roller 38.

For example, in all variants of FIGS. 1 to 3, the line load and/or the gap width of the first nip 18, the second nip 24, the third nip 26, possibly the fourth nip 32, the fifth nip 36, and/or the sixth nip 42 can be adjusted individually, that is, separately from one another, in a manner not shown in greater detail. Additionally or alternatively thereto, the gap width in the first nip 18, in the second nip 24, in the fourth nip 32, and/or in the fifth nip 36 is, or respectively will be regulated. Additionally or alternatively, the line load, that is, the nip force in the third nip 26 and/or in the sixth nip 42 is, or respectively will be regulated.

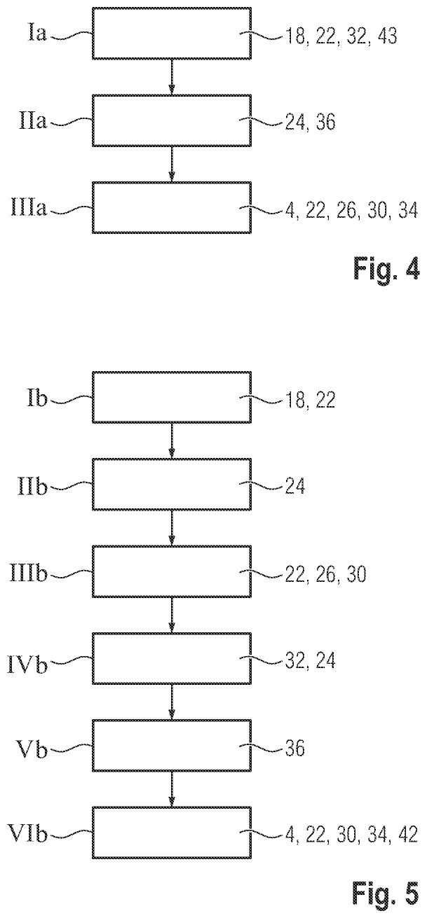

FIG. 4 shows a flow chart that represents a method for manufacturing the electrode according to a first variant. For this method, in particular the devices 2 according to FIG. 1 and/or FIG. 2 are used.

In a first step Ia, the solvent-free dry film material is conveyed into the first nip 18 and processed there into the first dry film 22. Moreover, the solvent-free dry film material is conveyed into the fourth nip 32 and is processed there into the second dry film 34.

In a second step IIa, the first dry film 22 is conveyed roller-borne on the second roller 8 into the second nip 24 and compressed there, and the second dry film is conveyed roller-borne on the sixth roller 16 into the fifth nip 36 and compressed there.

In a third step IIIa, the compressed first dry film 22 is conveyed roller-borne on the third roller 10 into the third nip 26. In addition, the compressed second dry film 34 is conveyed roller-borne on the fourth roller 12 into the third nip 26. The substrate 30 is conveyed into the third nip 26 such that it is arranged between the first and the second dry film 22, 34. In the third nip, the first dry film 22 and the second dry film 34 are laminated onto the substrate 30 while forming the electrode 4.

FIG. 5 shows a flow chart that represents a method for manufacturing the electrode according to a second variant. For this method, in particular the devices 2 according to FIG. 3 are used.

In a first step Ib, the solvent-free dry film material is conveyed into the first nip 18 and processed there into the first dry film 22.

In a second step IIb, the first dry film 22 is conveyed roller-borne on the second roller 8 into the second nip 24 and compressed there.

In a third step IIIb, the compressed first dry film 22 is conveyed roller-borne on the third roller 10 into the third nip 26. In addition, the substrate 30 is conveyed into the third nip 26, where the first dry film 22 is laminated onto the substrate 30. In this way, an electrode 4 is already formed whose substrate 30 is provided on only one side with a dry film, in this case the first dry film 22. The following steps are performed to the extent that an electrode 4 is to be manufactured with a substrate 30 provided with a dry film on both sides.

In a fourth step IVb, the solvent-free dry film material is conveyed into the fourth nip 32 and is processed there into the second dry film 34.

In a fifth step Vb, the second dry film 34 is conveyed roller-borne on the sixth roller 16 into the fifth nip 36 and compressed there.

In a sixth step VIb, the compressed second dry film 34 is conveyed roller-borne on the fourth roller 12 into the sixth nip 42. In addition, the substrate 30 laminated with the first dry film 22 is conveyed into the sixth nip 42 such that the substrate 30 is arranged between the first dry film 22 and the second dry film 34. In the sixth nip 42, the second dry film 34 is laminated onto the substrate 30 provided with the first dry film 22 while forming the electrode 4.

The invention is not limited to the exemplary embodiments described above. Instead, other variants of the invention can also be derived therefrom within the scope of the claims by a person skilled in the art without departing from the subject matter of the invention. In particular, all the individual features described in connection with the embodiments and/or in the claims can also be combined with one another in other ways without departing from the scope of the invention.

### LIST OF REFERENCE NUMERALS

2 Device
4 Electrode
6 First roller
8 Second roller
10 Third roller
12 Fourth roller
14 Fifth roller
16 Sixth roller
18 First nip
20 Conveying apparatus
22 First dry film
24 Second nip
26 Third nip
28 Feed apparatus
30 Substrate
32 Fourth nip
34 Second dry film
36 Fifth nip
38 Seventh roller
40 Eighth roller
42 Sixth nip
A (Rotational) axis of the roller
Ia Manufacture of the first dry film and the second dry film
IIa Compression of the first dry film and the second dry film
IIIa Lamination of the first and the second dry film on the substrate
Ib Manufacture of the first dry film
IIb Compression of the first dry film
IIb Lamination of the first dry film on the substrate
IVb Manufacture of the second dry film
Vb Compression of the second dry film
VIb Lamination of the second dry film on the substrate provided with the first dry film

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module, device, or other unit or device may fulfill the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for manufacturing an electrode with a substrate and with a first dry film, comprising:
to form a first dry film, bringing solvent-free dry film material into a first nip formed between a first roller and a second roller;
conveying the first dry film roller-borne into a second nip formed between the second roller and a third roller and compressing the first dry film therein; and
for lamination, conveying the compressed first dry film and the substrate into a third nip formed between the third roller and a fourth roller, wherein the first dry film is conveyed roller-borne into the third nip.

2. The method of claim 1, comprising:
to form a second dry film, bringing solvent-free dry film material into a fourth nip formed between a fifth roller and a sixth roller;
conveying the second dry film roller-borne into a fifth nip formed between the sixth roller and a seventh roller and compressing the second dry film therein; and
for joint lamination, conveying the compressed second dry film and the substrate laminated with the first dry film into a sixth nip formed between the seventh roller and an eighth roller, wherein the second dry film is conveyed roller-borne into the sixth nip.

3. The method of claim 1, comprising:
to form a second dry film, bringing solvent-free dry film material into a fourth nip formed between a fifth roller and a sixth roller;
conveying the second dry film roller-borne into a fifth nip formed between the sixth roller and the fourth roller and compressing the second dry film therein; and
for joint lamination, conveying the compressed second dry film, the substrate and the first dry film into the third nip, wherein the second dry film is conveyed roller-borne into the third nip.

4. The method of claim 1, wherein the first dry film is compressed in the second nip, and/or the second dry film is compressed in the sixth nip, in each case to a density between 1.0 g/cm³ and 4 g/cm³, in particular between 1.4 g/cm³ and 3.7 g/cm³.

5. The method of claim 1, wherein the first dry film is compressed in the second nip, and/or the second dry film is compressed in the sixth nip, in each case to a thickness between 10 μm and 200 μm, in particular between 40 μm and 120 μm.

6. The method of claim 1, wherein the circumferential speed of the second roller is greater than the circumferential speed of the first roller, and/or in that the circumferential speed of the third roller is greater than the circumferential speed of the second roller.

7. The method of claim 1, wherein the temperature of the second roller is adjusted to be greater than the temperature of the first roller, and/or the temperature of the third roller is greater than the temperature of the second roller.

8. The method of claim 1, wherein the surface of the second roller has a greater roughness than the surface of the first roller, and/or the surface of the third roller has a greater roughness than the surface of the second roller.

9. A device for manufacturing an electrode with a substrate and with a first dry film, having:
a first roller and a second roller, wherein a first nip is formed between the first roller and the second roller;
a conveying apparatus for conveying solvent-free dry film material into the first nip;
a third roller, wherein a second nip is formed between the second roller and the third roller for compressing a first dry film formed in the first nip;
a fourth roller, wherein a third nip is formed between the third roller and the fourth roller; and
a feed for feeding the substrate into the third nip.

10. The device of claim 9, wherein
the line load and/or the gap width of the first nip, the second nip and/or the third nip is individually adjustable, and/or
the gap width is regulated in the first nip and/or in the second nip, and/or the line load is regulated in the third nip.

11. The method of claim 1, wherein the substrate is foil-like.

12. The method of claim 2, wherein the first dry film is compressed in the second nip, and/or the second dry film is compressed in the sixth nip, in each case to a density between 1.0 g/cm³ and 4 g/cm³, in particular between 1.4 g/cm³ and 3.7 g/cm³.

13. The method of claim 3, wherein the first dry film is compressed in the second nip, and/or the second dry film is compressed in the sixth nip, in each case to a density between 1.0 g/cm³ and 4 g/cm³, in particular between 1.4 g/cm³ and 3.7 g/cm³.

14. The method of claim 2, wherein the first dry film is compressed in the second nip, and/or the second dry film is compressed in the sixth nip, in each case to a thickness between 10 μm and 200 μm, in particular between 40 μm and 120 μm.

15. The method of claim 3, wherein the first dry film is compressed in the second nip, and/or the second dry film is compressed in the sixth nip, in each case to a thickness between 10 μm and 200 μm, in particular between 40 μm and 120 μm.

16. The method of claim 4, wherein the first dry film is compressed in the second nip, and/or the second dry film is compressed in the sixth nip, in each case to a thickness between 10 μm and 200 μm, in particular between 40 μm and 120 μm.

17. The method of claim 2, wherein the circumferential speed of the second roller is greater than the circumferential speed of the first roller, and/or in that the circumferential speed of the third roller is greater than the circumferential speed of the second roller.

18. The method of claim 3, wherein the circumferential speed of the second roller is greater than the circumferential speed of the first roller, and/or in that the circumferential speed of the third roller is greater than the circumferential speed of the second roller.

19. The method of claim 4, wherein the circumferential speed of the second roller is greater than the circumferential speed of the first roller, and/or in that the circumferential speed of the third roller is greater than the circumferential speed of the second roller.

20. The method of claim 5, wherein the circumferential speed of the second roller is greater than the circumferential speed of the first roller, and/or in that the circumferential speed of the third roller is greater than the circumferential speed of the second roller.
